(19) United States
(12) Patent Application Publication
(10) Pub. No.: US 2024/0429446 A1
(43) Pub. Date: Dec. 26, 2024

(54) ELECTROLYTE SOLUTION FOR LITHIUM SECONDARY BATTERY AND LITHIUM SECONDARY BATTERY INCLUDING THE SAME

(71) Applicants: SK ON CO., LTD., Seoul (KR); SK INNOVATION CO., LTD., Seoul (KR)

(72) Inventors: Yu Na SHIM, Daejeon (KR); Jeong Yun KIM, Daejeon (KR); Hong Won LEE, Daejeon (KR)

(21) Appl. No.: 18/738,074

(22) Filed: Jun. 10, 2024

(30) Foreign Application Priority Data
Jun. 13, 2023 (KR) 10-2023-0075639

(51) Int. Cl. H01M 10/0567; H01M 10/052; H01M 10/0568; H01M 10/0569

(52) U.S. Cl. CPC H01M 10/0567; H01M 10/052; H01M 10/0568; H01M 10/0569; H01M 2300/0034; H01M 2300/0037

(57) ABSTRACT

An electrolyte solution for a lithium secondary battery according to embodiments of the present disclosure includes a lithium salt, an organic solvent, a phosphate-based additive and a radical remover. Flame retardancy and high-temperature stability of the electrolyte solution are improved, and a lithium secondary battery including the electrolyte solution and having improved high-temperature life-span and storage properties is be provided.

### CROSS-REFERENCE TO RELATED APPLICATION AND CLAIM OF PRIORITY

This application claims priority to Korean Patent Application No. 10-2023-0075639 filed on Jun. 13, 2023 in the Korean Intellectual Property Office (KIPO), the entire disclosure of which is incorporated by reference herein.

### TECHNICAL FIELD

The present disclosure relates to an electrolyte solution for a lithium secondary battery and a lithium secondary battery including the same. More particularly, the present disclosure relates to an electrolyte solution for a lithium secondary battery including an additive, and a lithium secondary battery including the same.

### BACKGROUND

A secondary battery which can be charged and discharged repeatedly has been widely employed as a power source of a mobile electronic device such as a camcorder, a mobile phone, a laptop computer, etc. Recently, a battery pack including the secondary battery is being developed and applied as a power source of an eco-friendly vehicle such as an electric automobile, a hybrid vehicle, etc.

Examples of the secondary battery include a lithium secondary battery, a nickel-cadmium battery, a nickel-hydrogen battery, etc. For example, the lithium secondary battery is widely developed and applied due to high operational voltage and energy density per unit weight, a high charging rate, a compact dimension, etc.

For example, the secondary battery may include an electrode assembly including a cathode, an anode and a separation layer (separator), and an electrolyte solution immersing the electrode assembly. The lithium secondary battery may further include an outer case having, e.g., a pouch shape for accommodating the electrode assembly and the electrolyte solution.

As an application range of the lithium secondary battery is expanded, developments of the lithium secondary battery having improved life-span, capacity and operation stability are progressed.

However, during repeated charging and discharging, surface damages of, e.g., a nickel-based lithium metal oxide used as a cathode active material may be caused to degrade power and capacity, and a side reaction between the nickel-based lithium metal oxide and an electrolyte may occur. Additionally, stability of the battery may be deteriorated in a harsh environment of high temperature or low temperature.

### SUMMARY

According to an aspect of the present disclosure, there is provided an electrolyte solution for a lithium secondary battery providing improved high temperature stability.

According to an aspect of the present invention, there is provided a lithium secondary battery including the electrolyte solution and having improved high temperature stability.

An electrolyte solution for a lithium secondary battery includes a lithium salt, an organic solvent, a phosphate-based additive including a compound represented by Chemical Formula 1, and a radical scavenger including a compound represented by Chemical Formula 2. A content of the phosphate-based additive is in a range from 1 wt % to 10 wt % based on a total weight of the electrolyte solution.

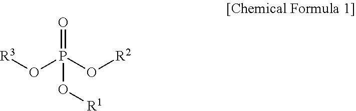

In Chemical Formula 1, R¹ to R³ are each independently a C6 to C18 aryl group, a C6 to C18 halogenated aryl group, a C1 to C10 alkyl group, a C1 to C10 halogenated alkyl group, or a C2 to C10 alkenyl group,

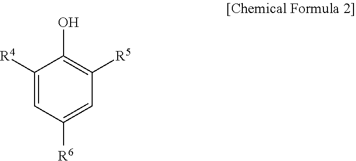

In Chemical Formula 2, R⁴ to R⁶ are each independently a C1 to C10 alkyl group, a C3 to C12 cycloalkyl group, a C2 to C10 alkenyl group, or a C6 to C18 aryl group.

In some embodiments, in Chemical Formula 1, R¹ and R² may be the same, and each of R¹ and R² may not be the same as R3, R¹ and R³ may be the same and each of R¹ and R³ may not be the same to R², or R¹, R² and R³ are not the same as each other.

In some embodiments, in Chemical Formula 1, R¹ and R² may each be independently a C6 to C18 aryl group, a C6 to C18 halogenated aryl group, a C1 to C10 alkyl group, a C1 to C10 halogenated alkyl group, or a C2 to C10 alkyl group, R³ may be a C6 to C18 aryl group, a C6 to C18 halogenated aryl group, or a C1 to C10 halogenated alkyl group, and at least one of R¹ and R² may not be the same as R³.

In some embodiments, in Chemical Formula 1, R¹ may be a C6 to C18 aryl group or a C6 to C18 halogenated aryl group, and R² may be a C1 to C5 halogenated alkyl group.

In some embodiments, in Chemical Formula 1, R¹ may be a phenyl group or a fluorophenyl group, R² may be a trifluoromethyl group, a 2,2,2-trifluoroethyl group, a 3,3,3-trifluoropropyl group, a 2,2,3,3,3-pentafluoropropyl group or a 2,2,3,3,4,4,4-heptafluorobutyl group, and R³ is phenyl group, a fluorophenyl group, a trifluoromethyl group, a 2,2,2-trifluoroethyl group, a 3,3,3-trifluoropropyl group, a 2,2,3,3,3-pentafluoropropyl group or a 2,2,3,3,4,4,4-heptafluorobutyl group.

In some embodiments, a content of the phosphate-based additive may be in a range from 5 wt % to 10 wt % based on the total weight of the electrolyte solution.

In some embodiments, in Chemical Formula 2, R⁴ and R⁵ may each be independently a C3 to C10 branched alkyl group.

In some embodiments, in Chemical Formula 2, R⁶ may be a C1 to C10 linear alkyl group.

In some embodiments, the radical scavenger may include 2,6-di-tert-butyl-p-cresol.

In some embodiments, a content of the radical scavenger may be in a range from 0.1 wt % to 2 wt % based on the total weight of the electrolyte solution.

In some embodiments, a ratio of the content of the phosphate-based additive to a content of the radical scavenger based on the total weight of the electrolyte solution is greater than 1, and less than or equal to 50.

In some embodiments, a ratio of the content of the phosphate-based additive to a content of the radical scavenger based on the total weight of the electrolyte solution is in a range from 2 to 20.

In some embodiments, the electrolyte solution may further include at least one auxiliary additive selected from the group consisting of a cyclic unsaturated carbonate-based compound, a fluorine-substituted cyclic carbonate-based compound, a sultone-based compound, a cyclic sulfate-based compound, a fluorine-substituted phosphate-based compound and an oxalato-borate-based compound.

In some embodiments, the auxiliary additive may be included in an amount from 0.01 wt % to 5 wt % based on the total weight of the electrolyte solution.

A lithium secondary battery includes a case, an electrode assembly including a cathode and an anode that faces the cathode and being accommodated in the case, and the electrolyte solution for a lithium secondary battery according to the above-described embodiments.

An electrolyte solution for a lithium secondary battery according to example embodiments of the present disclosure may include a phosphate-based additive and a radical scavenger. The phosphate-based additive may improve flame retardant properties and high-temperature stability of the electrolyte solution, and the radical scavenger may prevent components of the electrolyte solution from being decomposed or side reactions at high temperature. Accordingly, an amount of gas generated during high-temperature storage of the electrolyte solution and the battery including the same may be reduced.

Additionally, when the lithium secondary battery including the electrolyte solution is repeatedly charged and discharged at high temperature, an increase of a capacity and an internal resistance may be suppressed.

The electrolyte solution for a lithium secondary battery according to example embodiments of the present disclosure may include the phosphate-based additive and the radical scavenger in a desirable amount. Additionally, the electrolyte solution for a lithium secondary battery according to example embodiments of the present disclosure may include the phosphate-based additive and the radical scavenger in a desirable content ratio.

Accordingly, the lithium secondary battery including the electrolyte solution may have further improved high-temperature storage properties (e.g., reduced gas generation in the battery when stored at high temperature) and high-temperature life-span properties (e.g., increased capacity and resistance maintenance).

The lithium secondary battery of the present disclosure may be widely applied in green technology fields such as an electric vehicle, a battery charging station, a solar power generation, a wind power generation, etc., using a battery. The lithium secondary battery according to the present disclosure may be used for eco-friendly electric vehicles and hybrid vehicles to prevent a climate change by suppressing air pollution and greenhouse gas emission.

### BRIEF DESCRIPTION OF THE DRAWINGS

FIGS. 1 and 2 are a schematic plan view and a schematic cross-sectional view, respectively, illustrating a lithium secondary battery in accordance with example embodiments.

### DETAILED DESCRIPTION OF THE EMBODIMENTS

According to embodiments of the present disclosure, an electrolyte solution for a lithium secondary battery including a phosphate-based additive and a radical remover is provided. Additionally, a lithium secondary battery including the electrolyte solution having improved high-temperature storage properties and high-temperature life-span properties is provided,

### <Electrolyte Solution for Lithium Secondary Battery>

An electrolyte solution for a lithium secondary battery (hereinafter, abbreviated as electrolyte solution) according to embodiments of the present disclosure may include a lithium salt, an organic solvent, a phosphate-based additive and a radical scavenger.

In example embodiments, the organic solvent may be included in a remaining amount or a remainder excluding solid components such as the lithium salt, the phosphate-based additives, the radical scavenger, and an auxiliary additive. In some embodiments, a content of the organic solvent may be in a range from 90 weight percent (wt %) to 96 wt % based on a total weight of the electrolyte solution.

The organic solvent may include an organic compound capable of providing sufficient solubility for the lithium salt, the phosphate-based additive, the radical scavenger, the auxiliary additive, etc., and being not reactive with elements of the lithium secondary battery. In some embodiments, a non-aqueous organic solvent may be used, and the electrolyte solution may be provided as a non-aqueous electrolyte solution.

In one embodiment, the organic solvent may include a carbonate-based solvent, an ester-based solvent, an ether-based solvent, a ketone-based solvent, an alcohol-based solvent, an aprotic solvent, etc. These may be used alone or in combination of two or more therefrom.

Examples of the carbonate-based solvent include dimethyl carbonate (DMC), ethyl methyl carbonate (EMC), methyl propyl carbonate, ethyl propyl carbonate, diethyl carbonate (DEC), dipropyl carbonate, propylene carbonate (PC), ethylene carbonate (EC), butylene carbonate, etc.

Examples of the ester-based solvent include methyl acetate (MA), ethyl acetate (EA), n-propyl acetate (n-PA), 1,1-dimethylethyl acetate (DMEA), 2,2-difluoroethyl acetate (DFEA), 3,3,3-trifluoroethyl acetate, methyl propionate (MP), ethyl propionate (EP), gamma-butyrolactone (GBL), decanolide, valerolactone, mevalonolactone, caprolactone, etc.

Examples of the ether-based organic solvent include dibutyl ether, tetraethylene glycol dimethyl ether (TEGDME), diethylene glycol dimethyl ether (DEGDME), dimethoxy ethane, 2-methyltetrahydrofuran, tetrahydrofuran, etc.

Examples of the ketone-based solvent include cyclohexanone. Examples of the alcohol-based solvent include ethyl alcohol and isopropyl alcohol.

The aprotic solvent may include a nitrile-based solvent, an amide-based solvent such as dimethyl formamide (DMF), a dioxolane-based solvent such as 1,3-dioxolane, a sulfolane-based solvent, etc.

In an embodiment, the carbonate-based solvent may be used as the organic solvent. For example, the organic solvent may include ethylene carbonate (EC), ethyl methyl carbonate (EMC), dimethyl carbonate (DMC), diethyl carbonate (DEC), or a combination thereof.

In an embodiment, a combination of at least two of ethylene carbonate (EC), ethyl methyl carbonate (EMC), dimethyl carbonate (DMC) and diethyl carbonate (DEC) may be used as the organic solvent.

In example embodiments, the lithium salt may include one or more lithium salt compound. For example, the lithium salt may be expressed as Li⁺X⁻, and non-limiting examples of the anion (X⁻) of the lithium salt include PF₆⁻, F⁻, Cl⁻, Br⁻, I⁻, NO₃⁻, N(CN)₂⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂, SCN⁻, (CF₃CF₂SO₂)₂N⁻, BF₄⁻, BF₂(C₂O₄)⁻, B(C₃H₂O₄)₂⁻, BF₂(C₃H₂O₄)⁻, B(C₃HO₄F)₂⁻, B(C₃F₂O₄)₂⁻, etc. These may be used alone or in a combination of two or more therefrom.

In an embodiment, a concentration of the lithium salt in the electrolyte solution may be in a range from 0.01 M to 2 M, or from 0.5 M to 1.5 M. In the above range, transfer of lithium ions and/or electrons may be promoted during charging and discharging of the lithium secondary battery, and an improved capacity may be provided.

In example embodiments, the electrolyte solution may include the phosphate-based additive. The phosphate-based additive may improve a flame retardancy of the electrolyte solution and may improve high-temperature life-span and high-temperature storage properties of the lithium secondary battery by improving stability at high temperature.

The phosphate-based additive may include a compound represented by Chemical Formula 1 below.

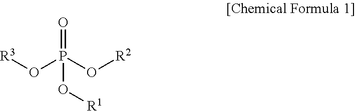

In Chemical Formula 1, R¹ to R³ may each independently be a C6 to C18 aryl group, a C6 to C18 halogenated aryl group, a C1 to C10 alkyl group, a C1 to C10 halogenated alkyl group, or a C2 to C10 alkenyl group.

The term “Ca to Cb” used herein refers that the number of carbon atoms in a hydrocarbon group is in a range from a to b.

The term “aryl group” used herein refers to a group containing at least one aromatic ring, and may include, e.g., a phenyl group, a naphthyl group, an anthracene group, etc.

The term “alkyl group” used herein refers to a chain-type saturated hydrocarbon that may include have a linear or branched alkyl group. For example, a C1 to C10 alkyl group may include a C1 to C10 linear alkyl group and a C3 to C10 branched alkyl group.

The “halogenated” used herein refers that at least one of hydrogen bonded to carbon of an alkyl group or an aryl group is replaced with a halogen atom such as Cl, Br, F or I.

The term “alkenyl group” used herein refers to a chain-type unsaturated hydrocarbon group containing a carbon-carbon double bond in a middle or an end of the chain.

The terms “alkyl group,” “alkenyl group,” and “aryl group” used herein may comprehensively refer to a substituted group or an unsubstituted group.

For example, the alkyl group, the cycloalkyl group, the alkenyl group and the aryl group may each include a substituent that replaces at least one hydrogen bonded to carbon.

Non-limiting examples of the substituent may include functional groups such as halogen, a hydroxy group, a carboxyl group, an amine group, an amide group, a cyano group, a thiol group, a sulfonic acid group, etc.

The halogenated alkyl group or halogenated aryl group may have 2 to 6 hydrogens bonded to a carbon atom. For example, if the halogenated alkyl group is a 2,2,3,3,4,4,4-heptafluorobutyl group, two hydrogens are bonded to carbon. If the halogenated aryl group is a fluorophenyl group, four hydrogens are bonded to carbon.

In example embodiments, R¹ to R³ may each independently be a C6 to C18 aryl group such as a phenyl group, a naphthyl group, an anthracene group, etc.; a C6 to C18 halogenated aryl group such as a fluorophenyl group, a difluorophenyl group, a trifluorophenyl group, a chlorophenyl group, a dichlorophenyl group, a trichlorophenyl group, a fluoronaphthyl group, etc.; a C1 to C10 alkyl group such as a methyl group, an ethyl group, an n-propyl group, an isopropyl group, an n-butyl group, an isobutyl group, an n-pentyl group, a neopentyl group, an isopentyl group; a C1 to C10 halogenated alkyl group such as a fluoromethyl group, a difluoromethyl group, a trifluoromethyl group, a 2-fluoroethyl group, a 2,2-difluoroethyl group, a 2,2,2-trifluoroethyl group, a 3-fluoropropyl group, a 3,3-difluoropropyl group, a 3,3,3-trifluoropropyl group, a 2,2,3,3,3-pentafluoropropyl group, a 4-fluorobutyl group, a 4,4-difluorobutyl group, a 4,4,4-trifluorobutyl group, a 3,3,4,4,4-pentafluorobutyl group, a 2,2,3,3,4,4,4-heptafluorobutyl group, etc.; or a C2 to C10 alkenyl group such as a vinyl group, a 1-propenyl group, a 2-propenyl group, an isopropenyl group, a 1-butenyl group, a 2-butenyl group, a 3-butenyl group, an isobutenyl group, a 2-methyl 2-butenyl group, etc.

In Chemical Formula 1, R¹ to R³ may be the same. In some embodiments, R¹ to R³ may be the same as each other, and may be a C6 to C18 aryl group, a C6 to C18 halogenated aryl group, or a C1 to C10 halogenated alkyl group. For example, R¹ to R³ may each be a phenyl group or a 2,2,2-trifluoroethyl group.

In Chemical Formula 1, at least one of R¹ and R² may not be the same as R³. For example, in Chemical Formula 1, R¹ and R² may be the same and may not be the same as R³.

For example, R¹ and R² may be the same C1 to C10 alkyl group or the same C2 to C10 alkenyl group. R3 may be a C6 to C18 aryl group, a C6 to C18 halogenated aryl group, or a C1 to C10 halogenated alkyl group, and may be different from R¹ and R².

For example, R¹ to R³ may be C6 to C18 aryl groups. R¹ and R² may be the same as each other and may be different from R³. For example, R¹ and R² may be a phenyl group and R³ may be a naphthyl group.

For example, R¹ and R² may be the same C6 to C18 aryl group, and R³ may be a C6 to C18 halogenated aryl group that may be different from R¹ and R². For example, R1 and R² may be a phenyl group and R³ may be a fluorophenyl group.

For example, R¹ and R² may be the same C6 to C18 halogenated aryl group, and R³ may be a C6 to C18 aryl group that may be different from R¹ and R². For example, R¹ and R² may be a fluorophenyl group and R3 may be a phenyl group.

For example, R¹ and R² may be the same C6 to C18 aryl group, and R³ may be a C6 to C18 halogenated aryl group that may be different from R¹ and R². For example, R¹ and R² may be a phenyl group and R³ may be a fluorophenyl group.

For example, R¹ to R³ may be C6 to C18 halogenated aryl groups. R¹ and R² may be the same as each other and may be different from R³. For example, R¹ and R² may be a fluorophenyl group, and R³ may be a difluorophenyl group.

For example, R¹ and R² may be the same C1 to C10 alkyl group, and R³ may be a C6 to C18 aryl group that may be different from R¹ and R². For example, R¹ and R² may be a methyl group, and R³ may be a phenyl group.

For example, R¹ and R² may be the same C2 to C10 alkenyl group, and R³ may be a C6 to C18 aryl group that may be different from R¹ and R². For example, R¹ and R² may be a vinyl group, and R³ may be a phenyl group.

For example, R¹ and R² may be the same C1 to C10 halogenated alkyl group, and R³ may be a C6 to C18 aryl group that may be different from R¹ and R². For example, R¹ and R² may be a 2,2,2-trifluoroethyl group, and R3 may be a phenyl group.

For example, R¹ to R³ may be C1 to C10 halogenated alkyl groups. R¹ and R² may be the same as each other and may be different from R³. For example, R¹ and R² may be a 2,2,2-trifluoroethyl group, and R³ may be a 3,3,3-trifluoropropyl group.

In some embodiments, in Chemical Formula 1, R¹ and R³ may be the same, and may be different from R², or R¹, R² and R³ may not be the same as each other.

In example embodiments, in Chemical Formula 1, R¹ may be a C6 to C18 aryl group or a C6 to C18 halogenated aryl group, and R² may be a C1 to C5 halogenated alkyl group.

In example embodiments, in Chemical Formula 1, R¹ may be a phenyl group or a fluorophenyl group, R² may be a trifluoromethyl group, 2,2,2-trifluoroethyl group, or 3,3,3-trifluoropropyl group, and R³ may be a phenyl group, a fluorophenyl group, a trifluoromethyl group, a 2,2,2-trifluoroethyl group or a 3,3,3-trifluoropropyl group.

For example, in Chemical Formula 1, R¹ may be a phenyl group, R² may be a 2,2,2-trifluoroethyl group, and R³ may be a phenyl group or a 2,2,2-trifluoroethyl group.

In example embodiments, the electrolyte solution may include the phosphate-based additive containing an aryl group or a halogenated alkyl group. The phosphate-based additive may enhance the flame retardancy of the electrolyte solution and may improve high-temperature stability of the electrolyte solution and the battery.

In example embodiments, the phosphate-based additive may include 50 weight percent (wt %) or more, 60 wt %, 70 wt %, 80 wt % or more, or 90 wt % or more of the compound represented by Chemical Formula 1 based on a total weight of the phosphate-based additive. In some embodiments, the phosphate-based additive may substantially consist of the compound represented by Chemical Formula 1.

In example embodiments, the phosphate-based additive may include two or more different compounds in which at least one of R¹, R² and R³ in the compound represented by Chemical Formula 1 are different. For example, the phosphate-based additive may include a mixture of a compound where R¹ and R² are a 2,2,2-trifluoroethyl group and R³ is a phenyl group in Chemical Formula 1 and a compound where R¹ and R² are a phenyl group and R³ is a 2,2,2-trifluoroethyl group in Chemical Formula 1.

In example embodiments, a content of the phosphate-based additive may be in a range from 1 wt % to 10 wt % based on a total weight of the electrolyte solution. For example, the content of the phosphate-based additive may be 1 wt % or more, 2 wt % or more, 3 wt % or more, 4 wt % or more, or 5 wt % or more, and 10 wt % or less, 9 wt % or less, 8 wt % or less, 7 wt % or less, or 6 wt % or less based on the total weight of the electrolyte solution.

In the above range, the flame retardancy of the electrolyte solution may be achieved, and excessive side reactions of the electrolyte solution at high temperature may be suppressed.

If the content of the phosphate-based additive is less than 1 wt %, the side reactions of the electrolyte solution may be increased and an excessive gas generation may be caused at an inside of the battery. Accordingly, the battery may expand to cause an increase in a battery thickness, and an energy density and a stability of the battery may be degraded.

If the content of the phosphate-based additive exceeds 10 wt %, the capacity may be lowered when the battery is repeatedly charged and discharged under high temperature conditions to cause deterioration of the life-span properties.

In example embodiments, the electrolyte solution may include the radical scavenger. The radical scavenger may remove radicals generated when the electrolyte solution decomposes at high temperature or when a side reaction between the electrolyte solution and an electrode material occurs. Accordingly, damages to the battery may be suppressed by preventing an additional side reaction or a heat generation/explosion therefrom.

When the electrolyte solution contains only the phosphate-based additive, the flame retardancy of the electrolyte solution may be obtained, but components of the electrolyte solution may be decomposed at high temperature or gas may be generated due to the side reaction of the electrolyte solution. The electrolyte solution according to embodiments of the present disclosure includes the radical scavenger, so that an amount of the gas generation from the battery in the high temperature environment may be reduced, and the battery having improved storage and life-span properties at high temperature.

In example embodiments, the radical scavenger may include a compound represented by Chemical Formula 2.

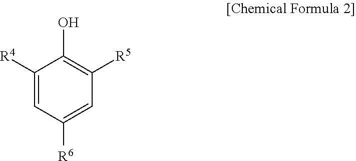

In Chemical Formula 2, R⁴ to R⁶ may each independently be a C1 to C10 alkyl group, a C3 to C12 cycloalkyl group, a C2 to C10 alkenyl group, or a C6 to C18 aryl group.

The term “cycloalkyl group” used herein refers to a cyclic saturated hydrocarbon and may include a structure in which at least two ends of a linear alkyl group or a branched alkyl group are connected.

The alkyl group, the alkenyl group and the aryl group may be the same as those described with reference to Chemical Formula 1. Additionally, the alkyl group, the cycloalkyl group, the alkenyl group and the aryl group may each include a substituent that replaces at least one hydrogen bonded to carbon.

Non-limiting examples of the substituent may include functional groups such as halogen, a hydroxy group, a carboxyl group, an amine group, an amide group, a cyano group, a thiol group, a sulfonic acid group, etc.

For example, in Chemical Formula 2, R⁴ to R⁶ may each independently be a C1 to C10 alkyl group such as a methyl group, an ethyl group, an n-propyl group, an isopropyl group, an n-butyl group, an isobutyl group, an n-pentyl group, a neopentyl group, an isopentyl group, etc.; a C3 to C12 cycloalkyl group such as a cyclopropyl group, a cyclobutyl group, a cyclopentyl group, a cyclohexyl group, a cycloheptyl group, a cyclooctyl group, etc.; a C2 to C10 alkenyl group such as a vinyl group, a 1-propenyl group, a 2-propenyl group, an isopropenyl group, a 1-butenyl group, a 2-butenyl group, a 3-butenyl group, an isobutenyl group, a 2-methyl 2-butenyl group, etc.; or a C6 to C18 aryl group such as a phenyl group, a naphthyl group, an anthracene group, etc.

In some embodiments, at least one alkylene group (—CH₂—) included in the alkyl group or the alkenyl group may be substituted with S, O, an amine group such as —NH—, or —NR— (R is a C1 to C5 alkyl group), a phosphanyl group such as —PH— or —PR— (R is an C1 to C5 alkyl group, an ester group, a carbonyl group, a disulfide group, a sulfonyl group, an azo group, a amide group, an imine group, a peroxy group, a carbonate group, a phosphate group, etc.

In example embodiments, in Chemical Formula 2, R⁴ and R⁵ may each independently be a C3 to C10 branched alkyl group. In some embodiments, R⁴ and R⁵ may be a C3 to C5 branched alkyl group, for example, may each be a tert-butyl group.

In Chemical Formula 2, R⁶ may be bonded to a para position of a hydroxy group. In this case, the substituent is bonded to the position with a less steric hindrance and may not inhibit a radical capturing activity of the hydroxy group.

In example embodiments, in Chemical Formula 2, R⁶ may be a C1 to C10 linear alkyl group. In some embodiments, R⁶ may be a C1 to C3 linear alkyl group, e.g., a methyl group.

In example embodiments, the radical scavenger may include 2,6-di-tert-butyl-p-cresol represented as Chemical Formula 2-1 below.

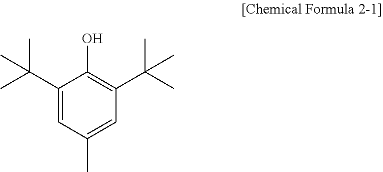 [SMILES: Cc1cc(C(C)(C)C)c(O)c(C(C)(C)C)c1]

In example embodiments, a content of the radical scavenger may be in a range from 0.1 wt % to 2 wt % based on the total weight of the electrolyte solution. In some embodiments, the content of the radical scavenger may be in a range from 0.1 wt % to 1 wt %, or from 0.1 wt % to 0.5 wt % based on the total weight of the electrolyte solution. In the above range, radicals generated in the electrolyte solution at high temperature may be more effectively capture by the radical scavenger. Thus, the high-temperature stability of the electrolyte solution may be further improved.

In example embodiments, the radical scavenger may include a di-tert-butyl hydroxyphenyl group-containing compound in an amount of 50 wt % or more, 60 wt % or more, 70 wt % or more, 80 wt % or more, or 90 wt % or more based on a total weight of the radical scavenger. In some embodiments, the radical scavenger may substantially consist of the di-tert-butyl hydroxyphenyl group-containing compound.

In example embodiments, a ratio of the content (wt %) of the phosphate-based additive to the content (wt %) of the radical scavenger may be greater than 1 and less than or equal to 50. In some embodiments, the ratio of the content of the phosphate-based additive to the content of the radical scavenger may be in a range from 2 to 20, or from 5 to 17.

In the above range, a volume expansion of the battery may be prevented by reducing the amount of gas generation while appropriately maintaining the flame retardancy of the electrolyte solution.

In example embodiments, the electrolyte solution may further include an auxiliary additive. The auxiliary additive may be included in an amount of 0.01 wt % to 5 wt % based on the total weight of the electrolyte solution. In some embodiments, the content of the auxiliary additive may be in a range from 0.1 wt % to 4 wt %.

For example, the auxiliary additive may include a cyclic unsaturated carbonate-based compound, a fluorine-substituted cyclic carbonate-based compound, a sultone-based compound, a cyclic sulfate-based compound, a fluorine-substituted phosphate-based compound, an oxalato borate-based compound, etc.

The cyclic unsaturated carbonate-based compound may be a compound different from the organic solvent and may include vinyl ethylene carbonate (VEC). The cyclic unsaturated carbonate-based compound may include a double bond, and may include, e.g., vinylene carbonate (VC).

The fluorine-substituted cyclic carbonate-based compound may include fluoroethylene carbonate (FEC).

The sultone-based compound may include 1,3-propane sultone, 1,3-propene sultone, 1,4-butane sultone. etc.

The cyclic sulfate-based compound may include 1,2-ethylene sulfate, 1,2-propylene sulfate, etc.

The fluorine-substituted phosphate-based compound may include lithium difluorophosphate (LiPO₂F₂). The fluorine-substituted phosphate-based compound may include a fluorine-substituted oxalatophosphate-based compound, and may include, e.g., lithium difluoro bis(oxalato)phosphate (LiPF₂(C₂O₄)₂).

The oxalato borate-based compound may include lithium bis(oxalato)borate (LiB(C₂O₄)₂).

In an embodiment, the fluorine-substituted cyclic carbonate-based compound, the sultone-based compound and then oxalato borate-based compound may be used together as the auxiliary additive.

The auxiliary additive may be added so that durability and stability of the electrode may be further improved. The auxiliary additive may be included in an appropriate amount within a range that may not inhibit mobility of lithium ions in the electrolyte solution.

### <Lithium Secondary Battery>

According to embodiments of the present disclosure, a lithium secondary battery including the above-described electrolyte solution is provided.

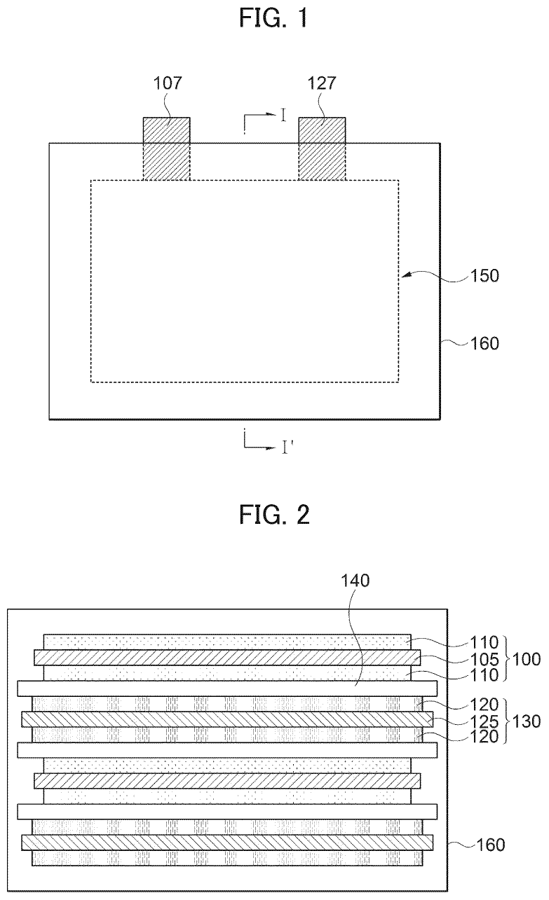

FIGS. 1 and 2 are a schematic plan view and a cross-sectional view, respectively, illustrating a lithium secondary battery according to example embodiments. For example, FIG. 2 is a cross-sectional view taken along a line I-I′ of FIG. 1 in a thickness direction.

Referring to FIGS. 1 and 2, a lithium secondary battery may include an electrode assembly including a cathode 100, an anode, and a separator 140 interposed between the cathode and the anode.

The electrode assembly may be accommodated with the electrolyte solution according to the above-described embodiments in a case 160 to be impregnated therein.

The cathode 100 may include a cathode active material layer 110 formed by coating a cathode active material on a cathode current collector 105. The cathode active material may include a compound capable of reversibly intercalating and de-intercalating lithium ions.

In example embodiments, the cathode active material may include a lithium-transition metal oxide. For example, the lithium-transition metal oxide may include nickel (Ni), and may further include at least one of cobalt (Co) or manganese (Mn).

For example, the lithium-transition metal oxide may be represented by Chemical Formula 3 below.

Li₁₊ₐNi_{1-(x+y)}CoₓM_{y}O₂ [Chemical Formula 3]

In Chemical Formula 3, −0.05≤a≤0.2, 0.01≤x≤0.3, 0.01≤y≤0.3, and M may include at least selected from Mn, Mg, Sr, Ba, B, Al, Si, Ti, Zr and W.

As expressed in Chemical Formula 3, the lithium-transition metal oxide may contain Ni in the highest content or molar ratio among Ni, Co and M. Ni may substantially serve as a metal related to a power and/or a capacity of the lithium secondary battery. Ni may be included in the largest amount among transition metals, so that the high-capacity and high-power output lithium secondary battery may be implemented.

In an embodiment, in Chemical Formula 3, 0.01≤x≤0.2 and 0.01≤y≤0.2. In an embodiment, the molar ratio of Ni may be 0.7 or more, or 0.8 or more.

A slurry may be prepared by mixing and stirring the cathode active material with a binder, a conductive material and/or a dispersant in a solvent. The slurry may be coated on the cathode current collector 105, and then dried and pressed to form the cathode 100.

The cathode current collector 105 may include stainless steel, nickel, aluminum, titanium, copper, or an alloy thereof. For example, the cathode current collector 105 may include, e.g., aluminum or an aluminum alloy.

The binder may include an organic binder such as vinylidene fluoride-hexafluoropropylene copolymer (PVDF-co-HFP), polyvinylidenefluoride (PVDF), polyacrylonitrile, polymethylmethacrylate, or an aqueous binder such as styrene-butadiene rubber (SBR), and may be used with a thickener such as carboxymethyl cellulose (CMC).

For example, a PVDF-based binder may be used as the cathode binder. In this case, an amount of the binder for forming the cathode active material layer may be reduced, and an amount of the cathode active material may be relatively increased. Thus, the capacity and power of the lithium secondary battery may be further improved.

The conductive material may be added to facilitate electron mobility between active material particles. For example, the conductive material may include a carbon-based material such as graphite, carbon black, graphene, carbon nanotube, etc., and/or a metal-based material such as tin, tin oxide, titanium oxide, a perovskite material such as LaSrCoO₃ or LaSrMnO₃, etc.

The anode 130 may include an anode current collector 125 and an anode active material layer 120 formed by coating anode active material on the anode current collector 125.

A material capable of adsorbing and desorbing lithium ions which may be widely known in the related art may be used as the anode active material without particular limitation. For example, a carbon-based material such as a crystalline carbon, an amorphous carbon, a carbon composite, a carbon fiber, etc.; a lithium alloy; a silicon (Si)-based compound or tin may be used.

Examples of the amorphous carbon include hard carbon, cokes, a mesocarbon microbead (MCMB), a mesophase pitch-based carbon fiber (MPCF), etc.

Examples of the crystalline carbon include a graphite-based carbon such as natural graphite, artificial graphite, a graphitized cokes, a graphitized MCMB, a graphitized MPCF, etc. Elements included in the lithium alloy include aluminum, zinc, bismuth, cadmium, antimony, silicon, lead, tin, gallium, indium, etc.

The silicon-based compound may include, e.g., silicon, a silicon oxide, or a silicon-carbon composite compound such as or silicon carbide (SiC).

For example, the anode active material may be mixed and stirred with and the above-described binder, the conductive material, the thickener, etc., in a solvent to form a slurry. The slurry may be coated on at least one surface of the anode current collector 125, and then dried and pressed to form the anode 130.

The separator 140 may be interposed between the cathode 100 and the anode 130. The separator 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separator 140 may also include a non-woven fabric formed from a glass fiber with a high melting point, a polyethylene terephthalate fiber, etc.

In some embodiments, an area and/or a volume of the anode 130 (e.g., a contact area with the separator 140) may be greater than that of the cathode 100. Thus, lithium ions generated from the cathode 100 may be easily transferred to the anode 130 without a loss by, e.g., precipitation or sedimentation.

In example embodiments, an electrode cell may be defined by the cathode 100, the anode 130 and the separator 140, and a plurality of the electrode cells may be stacked to form the electrode assembly 150 that may have e.g., a jelly roll shape. For example, the electrode assembly 150 may be formed by winding, stacking or folding the separator 140.

The electrode assembly 150 may be accommodated together with the electrolyte solution according to the above-described embodiments of the present disclosure in the case 160.

As illustrated in FIG. 1, electrode tabs (a cathode tab and an anode tab) may protrude from the cathode current collector 105 and the anode current collector 125 included in each electrode cell to one side of the case 160. The electrode tabs may be welded together with the one side of the case 160 to be connected to an electrode lead (a cathode lead 107 and an anode lead 127) that may be extended or exposed to an outside of the case 160.

The lithium secondary battery may be fabricated into a cylindrical shape using a can, a prismatic shape, a pouch shape, a coin shape, etc.

Hereinafter, exemplary experimental examples are proposed to more concretely describe the present disclosure. However, the following examples are only given for illustrating the present invention and those skilled in the related art will obviously understand that various alterations and modifications are possible within the scope and spirit of the present invention. Such alterations and modifications are duly included in the appended claims.

### Synthesis Example 1

Phenyl bis(trifluoroethyl) phosphate was synthesized as a compound represented by Chemical Formula 1-1.

100 ml of dichloromethane was measured and put in a 500 ml round bottom flask, and then cooled to 0° C. and 10 g (47.4 mmol) of phenyl dichlorophosphate and 12 g (118 mmol) of triethylamine were weighed and mixed. Thereafter, while maintaining a temperature at 0° C. in a nitrogen environment, 10.4 g (104.3 mmol) of 2,2,2-trifluoroethanol was slowly added over 20 minutes and stirred at room temperature for 24 hours.

After the reaction, an organic layer was mixed and extracted once with an aqueous hydrochloric acid solution and twice with distilled water, and then the organic layer was vacuum dried to remove a solvent and moisture. The obtained solution was purified using a silica column to obtain 11.7 g with a yield of 73%.

1H-NMR chemical shift (500 MHz, Acetone-d6), δ: 7.46-7.48 (m, 2H), 7.28-7.33 (m, 3H), 4.79-4.85 (m, 4H)

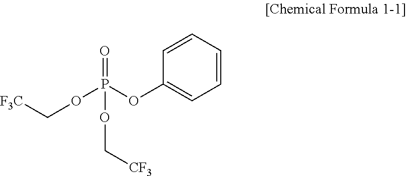 [SMILES: O=P(OCC(F)(F)F)(OCC(F)(F)F)Oc1ccccc1]

### Synthesis Example 2

Diphenyl trifluoroethyl phosphate was synthesized as a compound represented by Chemical Formula 1-2.

After putting 100 ml of dichloromethane in a 500 ml round-bottom flask and cooled to 0° C., 10 g (37.2 mmol) of diphenyl chlorophosphate and 8.3 g (81.8 mmol) of triethylamine were quantified and mixed. Thereafter, 7.7 g (76.3 mmol) of 2,2,2-trifluoroethanol was slowly added for 20 minutes under a nitrogen environment, followed by stirring at room temperature for 24 hours.

After the above-described reaction, an organic layer was mixed and extracted once with an aqueous hydrochloric acid solution and twice with distilled water, and then the organic layer was vacuum dried to remove a solvent and moisture. The obtained solution was purified by a silica column to obtain 9.89 g with a yield of 80%.

1H-NMR chemical shift (500 MHz, Acetone-d6), δ: 7.44-7.48 (m, 4H), 7.28-7.37 (m, 6H), 4.88-4.91 (m, 2H)

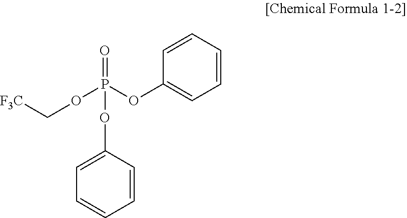 [SMILES: O=P(OCC(F)(F)F)(Oc1ccccc1)Oc1ccccc1]

### Synthetic Example 3

Tris(4-fluorophenyl)phosphate was synthesized as a compound represented by Chemical Formula 1-3.

After 300 ml of toluene was quantified and put in a 500 ml round-bottom flask, 50 g (446 mmol) of 4-fluorophenol and 19.6 g (491 mmol) of sodium hydroxide were quantified and mixed. Thereafter, the mixture was stirred vigorously for 1.5 hours while maintaining 0° C. in a nitrogen environment, and then 20.7 g (135 mmol) of phosphorus oxychloride (POCl₃) was slowly added and stirred at room temperature for 21 hours.

After the above-described reaction, 200 mL of a 10% aqueous sodium hydroxide solution was mixed and stirred for 15 minutes, and then the organic solvent layer was separated. The obtained organic solvent layer was mixed three times with distilled water and extracted, and then the organic solvent layer was vacuum-dried to remove the solvent and moisture, thereby obtaining 46.7 g with a yield of 87.8%.

1H-NMR chemical shift (500 MHz, Acetone-d6), δ: 7.32-7.38 (m, 6H), 7.18-7.26 (m, 6H)

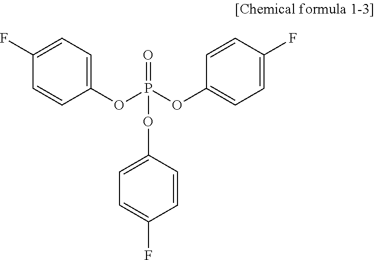 [SMILES: O=P(Oc1ccc(F)cc1)(Oc1ccc(F)cc1)Oc1ccc(F)cc1]

### Synthetic Example 4

Bis(2,2,3,3,3-pentafluoro-1-propyl) phenyl phosphate was synthesized as a compound represented by Chemical Formula 1-4.

After quantifying and putting 100 ml of tetrohydrofuran in a 500-ml round-bottom flask, the mixture is cooled to 0° C. and 10 g (66.7 mmol) of pentafluoropropanol and 1.64 g (68.3 mmol) of sodium hydride were quantified and mixed. Thereafter, the mixture was stirred for 2 hours while maintaining 0° C. in a nitrogen environment, and then, 6.9 g (32.5 mmol) of phenyl dichlorophosphate was slowly added for 10 minutes and stirred at 60° C. for 24 hours.

After the above-described reaction, the organic solvent was removed by cooling to room temperature and drying under reduced pressure. 100 mL of dichloromethane was added and dissolved, neutralization was performed with an aqueous hydrogen chloride solution and an aqueous sodium hydroxide solution, and an organic layer was mixed and extracted twice with distilled water. The organic layer was vacuum-dried to remove a solvent and moisture. The obtained solution was purified by a silica column to obtain 7.3 g with a yield of 66%.

1H-NMR chemical shift (500 MHz, Acetone-d6), δ: 7.46-7.47 (m, 2H), 7.30-7.32 (m, 3H), 4.86-4.94 (m, 4H)

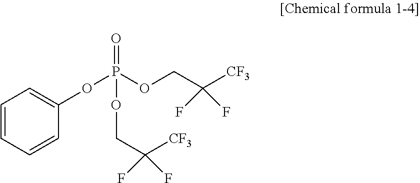 [SMILES: O=P(OCC(F)(F)C(F)(F)F)(OCC(F)(F)C(F)(F)F)Oc1ccccc1]

### Synthetic Example 5

Bis(2,2,3,3,4,4,4-heptafluoro-1-butyl) phenyl phosphate was synthesized as a compound represented by Chemical Formula 1-5.

After quantifying and putting 100 ml of dichloromethane in a 500 ml round-bottom flask, 10 g (47.4 mmol) of phenyl dichlorophosphate and 10.6 g (105 mmol) of triethylamine were quantified and mixed. Thereafter, 19.9 g (99.5 mmol) of hexafluorobutanol was slowly added for 30 minutes while maintaining a nitrogen environment, and the mixture was stirred at room temperature for 72 hours.

After the above-described reaction, neutralization was performed with a hydrogen chloride aqueous solution and a sodium hydroxide aqueous solution, and then an organic layer was mixed and extracted twice with distilled water. The organic layer was vacuum-dried to remove a solvent and moisture. The obtained solution was purified by a silica column to obtain 14.1 g with a yield of 55%.

1H-NMR chemical shift (500 MHz, Acetone-d6), δ: 7.47-7.51 (m, 2H), 7.30-7.33 (m, 3H), 4.90-4.99 (m, 4H)

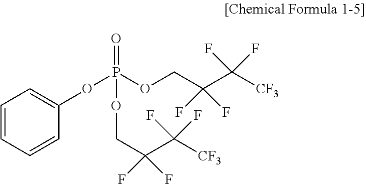 [SMILES: O=P(OCC(F)(F)C(F)(F)C(F)(F)F)(OCC(F)(F)C(F)(F)C(F)(F)F)Oc1ccccc1]

### Synthetic Example 6

Triphenyl phosphate was synthesized as a compound represented by Chemical Formula 1-6.

After quantifying and putting 200 ml of dichloromethane in a 500 ml round-bottom flask, 20 g (213 mmol) of phenol and 22.2 g (219 mmol) of triethylamine were quantified and mixed. After stirring vigorously for 1 hour while maintaining 0° C. in a nitrogen environment, 10.5 g (69 mmol) of phosphorous oxychloride (POCl3) was slowly dropped into the reactor. The mixture was stirred at room temperature for an additional 18 hours while maintaining a nitrogen environment.

After mixing and extracting 100 ml of 10% NaOH aqueous solution and 100 ml of water twice to the obtained organic solvent layer, the organic solvent layer was vacuum-dried to remove a solvent and moisture. The obtained solution was purified by silica column to obtain 13.9 g with a yield of 62%.

1H-NMR chemical shift (500 MHz, Acetone-d6), δ: 7.44-7.19 (m, 15H).

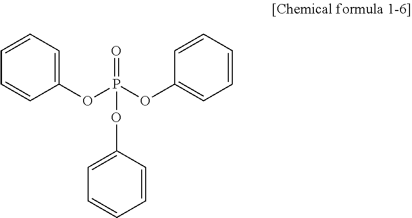 [SMILES: O=P(Oc1ccccc1)(Oc1ccccc1)Oc1ccccc1]

### Synthesis Example 7

Tris(trifluoroethyl) phosphate was synthesized as a compound represented by Chemical Formula 1-7.

After quantifying and putting 200 ml of dichloromethane in a 500 ml round bottom flask, 20 g (200 mmol) of 2,2,2-trifluoroethanol and 14.0 g (206 mmol) of imidazole were weighed and mixed. After stirring vigorously for 1.5 hours while maintaining 0° C. in a nitrogen environment, 9.89 g (64 mmol) of phosphorous oxychloride (POCl₃) was slowly dropped into the reactor. The mixture was additionally stirred for 21 hours at room temperature while maintaining the nitrogen environment.

After the above-described reaction, 200 ml of 10 wt % NaOH was mixed to quench a remaining starting material, and an organic solvent layer was separated. The obtained organic solvent layer was mixed and extracted with 200 ml of water three times, and then the organic solvent layer was vacuum-dried to remove a solvent and moisture. The obtained solution was purified using a silica column to obtain 11.98 g with a yield of 54%.

1H-NMR chemical shift (500 MHz, Acetone-d6), δ: 4.26-4.15 (m, 6H)

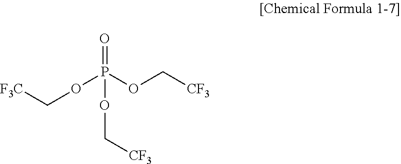 [SMILES: O=P(OCC(F)(F)F)(OCC(F)(F)F)OCC(F)(F)F]

### Example 1

### (1) Preparation of Electrolyte Solution

An 1M LiPF₆ solution (using a mixed solvent of ethylene carbonate (EC) and ethylmethyl carbonate (EMC), volume ratio EC:EMC=25:75) was prepared. Based on a total weight of an electrolyte solution, 1 wt % of fluoroethylene carbonate, 0.5 wt % of 1,3-propane sultone (PS), 0.5 wt % of 1,3-propene sultone (PRS) and 0.3 wt % of lithium bis(oxalato)borate were added in the 1M LiPF₆ solution, and 5 wt % of the compound synthesized in Synthesis Example 1 as a phosphate-based additive and 0.5 wt % of 2,6-di-tert-butyl-p-cresol (Sigma Aldrich) represented by Chemical Formula 2-1 below as a radical scavenger were added.

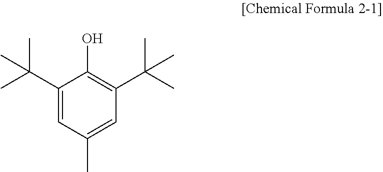 [SMILES: Cc1cc(C(C)(C)C)c(O)c(C(C)(C)C)c1]

### (2) Fabrication of Lithium Secondary Battery Sample

A cathode active material in which Li[Ni_{0.6}Co_{0.2}Mn_{0.2}]O₂ and Li[Ni_{0.8}Co_{0.1}Mn_{0.1}]O₂ were mixed in a weight ratio of 6:4, carbon black as a conductive material and polyvinylidene fluoride (PVDF) as a binder were mixed in a weight ratio of 92:5:3 to prepare a slurry. The slurry was uniformly coated on an aluminum foil having a thickness of 15 μm, and vacuum-dried and pressed at 130° C. to prepare a cathode for a lithium secondary battery.

An anode slurry including 95 wt % of an anode active material in which artificial graphite and natural graphite were mixed in a weight ratio of 7:3, 1 wt % of Super-P as a conductive material, 2 wt % of styrene-butadiene rubber (SBR) as a binder, and 2 wt % of carboxymethyl cellulose (CMC) as a thickener was prepared. The anode slurry was uniformly coated, dried and pressed on a copper foil having a thickness of 15 m to prepare an anode.

The above-prepared cathode and anode was cut in a predetermined sized and stacked by interposing a separator (polyethylene, thickness of 20 μm) therebetween to form an electrode assembly, and tab portions of the cathode and the anode were welded.

The electrode assembly was placed in a pouch and three sides were sealed except for an electrolyte injection side. Regions around the tab portions were included in the sealing portion. The electrolyte solution prepared in the above (1) was injected through the electrolyte injection side, and then the electrolyte injection side was also sealed. Thereafter, the electrode assembly was impregnated for 12 hours or more to prepare a lithium secondary battery sample.

### Example 2

A secondary battery sample was prepared by the same method as that in Example 1, except that the compound synthesized in Synthesis Example 2 was used instead of the compound synthesized in Synthesis Example 1 when preparing the electrolyte solution.

### Example 3

A secondary battery sample was prepared by the same method as that in Example 1, except that the compound synthesized in Synthesis Example 3 was used instead of the compound synthesized in Synthesis Example 1 when preparing the electrolyte solution.

### Example 4

A secondary battery sample was prepared by the same method as that in Example 1, except that the compound synthesized in Synthesis Example 4 was used instead of the compound synthesized in Synthesis Example 1 when preparing the electrolyte solution.

### Example 5

A secondary battery sample was prepared by the same method as that in Example 1, except that the compound synthesized in Synthesis Example 5 was used instead of the compound synthesized in Synthesis Example 1 when preparing the electrolyte solution.

### Example 6

A secondary battery sample was prepared by the same method as that in Example 1, except that the compound synthesized in Synthesis Example 6 was used instead of the compound synthesized in Synthesis Example 1 when preparing the electrolyte solution.

### Example 7

A secondary battery sample was prepared by the same method as that in Example 1, except that the compound synthesized in Synthesis Example 7 was used instead of the compound synthesized in Synthesis Example 1 when preparing the electrolyte solution.

### Example 8

A secondary battery sample was prepared by the same method as that in Example 1, except that 1 wt % of the compound synthesized in Synthesis Example 6 was added instead of the compound synthesized in Synthesis Example 1 when preparing the electrolyte solution.

### Example 9

A secondary battery sample was prepared by the same method as that in Example 1, except that 10 wt % of the compound synthesized in Synthesis Example 6 was added instead of the compound synthesized in Synthesis Example 1 when preparing the electrolyte solution.

### Example 10

A secondary battery sample was prepared by the same method as that in Example 6, except that 0.1 wt % of the radical scavenger was added when preparing the electrolyte solution.

### Example 11

A secondary battery sample was prepared by the same method as that in Example 6, except that 0.3 wt % of the radical scavenger was added when preparing the electrolyte solution.

### Example 12

A secondary battery sample was prepared by the same method as that in Example 6, except that 0.7 wt % of the radical scavenger was added when preparing the electrolyte solution.

### Comparative Example 1

A secondary battery sample was prepared by the same method as that in Example 1, except that the compound synthesized in Synthesis Example 6 was used instead of the compound synthesized in Synthesis Example 1 and the radical scavenger was not added when preparing the electrolyte solution.

### Comparative Example 2

A secondary battery sample was prepared by the same method as that in Example 1, except that the compound synthesized in Synthesis Example 7 was used instead of the compound synthesized in Synthesis Example 1 and the radical scavenger was not added when preparing the electrolyte solution.

### Comparative Example 3

A secondary battery sample was prepared by the same method as that in Example 1, except that 0.5 wt % of the compound synthesized in Synthesis Example 6 was added instead of the compound synthesized in Synthesis Example 1 when preparing the electrolyte solution.

### Comparative Example 4

A secondary battery sample was prepared by the same method as that in Example 1, except that 12 wt % of the compound synthesized in Synthesis Example 6 was added instead of the compound synthesized in Synthesis Example 1 when preparing the electrolyte solution.

### Comparative Example 5

A secondary battery sample was prepared by the same method as that in Example 1, except that 0.05 wt % of the radical scavenger was added when preparing the electrolyte solution.

### Comparative Example 6

A secondary battery sample was prepared by the same method as that in Example 1, except that the compound synthesized in Synthesis Example 1 and the radical scavenger were not added when preparing the electrolyte solution.

Table 1 below shows compositions of the electrolyte solution in Examples and Comparative Examples. The type of phosphate-based additive were expressed by the number of Synthesis Example, and the content was expressed in a unit of wt % based on a total weight of the electrolyte solution.

TABLE 1

| | phosphate-based additive | | | |
|---|---|---|---|---|
| | type | | radical scavenger | |
| | (Synthesis | content | | content |
| | Example) | (wt %) | addition | (wt %) |
| Example 1 | 1 | 5 | ◯ | 0.5 |
| Example 2 | 2 | 5 | ◯ | 0.5 |
| Example 3 | 3 | 5 | ◯ | 0.5 |
| Example 4 | 4 | 5 | ◯ | 0.5 |
| Example 5 | 5 | 5 | ◯ | 0.5 |
| Example 6 | 6 | 5 | ◯ | 0.5 |
| Example 7 | 7 | 5 | ◯ | 0.5 |
| Example 8 | 6 | 1 | ◯ | 0.5 |
| Example 9 | 6 | 10 | ◯ | 0.5 |
| Example 10 | 6 | 5 | ◯ | 0.1 |
| Example 11 | 6 | 5 | ◯ | 0.3 |
| Example 12 | 6 | 5 | ◯ | 0.7 |
| Comparative | 6 | 5 | X | — |
| Example 1 | | | | |
| Comparative | 7 | 5 | X | — |
| Example 2 | | | | |
| Comparative | 6 | 0.5 | ◯ | 0.5 |
| Example 3 | | | | |
| Comparative | 6 | 12 | ◯ | 0.5 |
| Example 4 | | | | |
| Comparative | 6 | 5 | ◯ | 0.05 |
| Example 5 | | | | |
| Comparative | — | — | X | — |
| Example 6 | | | | |

### Experimental Example

High-temperature storage properties of the battery samples were evaluated in accordance with the following experimental method, and the results are shown in Table 2.

### (1) Measurement of DCIR Increase Ratio

For each of the secondary battery samples of Examples and Comparative Examples before high-temperature storage, a C-rate was increased to 0.2 C, 0.5 C, 1.0 C, 1.5 C, 2.0 C, 2.5 C and 3.0 C at 60% of SOC, and end points of voltages were configured as a straight equation when a discharge at each the corresponding C-rate was performed for 10 seconds, and a slope thereof was adopted as an initial DCIR.

Each of the secondary battery samples of Example and Comparative Example was left at a temperature of 60° C. for 13 weeks and stored at a high temperature, and the DCIR was measured at room temperature after the completion of the high temperature storage, and a DCIR increase ratio was calculated as a percentage compared to the initial DCIR.

$$DCIR Increase Ratio ( \% ) = ( DCIR after high temperature storage / initial DCIR ) \times 100$$

### (2) Measurement of Capacity Retention

Each of the secondary battery samples of Examples and Comparative Examples before the high-temperature storage was 0.5 C-rate CC/CV charged (4.2V, 0.05 C cut-off), and then 0.5 C-rate CC discharged (2.7V cut-off) at 25° C. to a measure discharge capacity. The above cycle was performed three times to calculate an average value as an initial capacity.

As described in the above (1), the secondary battery samples of Example and Comparative Example were left at 60° C. for 13 weeks and stored at the high temperature, and then 0.5 C-rate CC discharge (2.7V cut-off) was performed at room temperature after the completion of the high-temperature storage. Thereafter, a discharge capacity was measured.

A capacity retention was calculated as a percentage of the discharge capacity after the high-temperature storage relative to the initial capacity.

$$Capacity Retention ( \% ) = ( discharge capacity after high temperature storage / initial capacity ) \times 100$$

### (3) Measurement of Thickness Increase Ratio

For each of the secondary battery samples of Examples and Comparative Examples before the high-temperature storage, a thickness of a central point was measured. The secondary battery samples were stored at high temperature as described in the above (1), and then the thickness of the same point was measured again.

A thickness increase ratio was calculated as a percentage of the battery thickness after the high-temperature storage relative to the initial thickness.

$$Thickness Increase Ratio ( \% ) = ( battery thickness after high temperature storage / initial thickness ) \times 100$$

TABLE 2

| | 60° C. high temperature storage | | | |
|---|---|---|---|---|
| | properties, 13 weeks | | | |
| | | thickness | capacity | DCIR |
| | thickness | increase | retention | increase |
| | (mm) | ratio (%) | (%) | ratio (%) |
| Example 1 | 8.25 | 140 | 82 | 117 |
| Example 2 | 7.44 | 133 | 83 | 115 |
| Example 3 | 9.32 | 152 | 83 | 109 |
| Example 4 | 7.04 | 128 | 87 | 110 |
| Example 5 | 7.13 | 129 | 86 | 111 |
| Example 6 | 10.24 | 172 | 87 | 107 |
| Example 7 | 6.84 | 109 | 83 | 119 |
| Example 8 | 9.97 | 164 | 88 | 108 |
| Example 9 | 8.18 | 136 | 83 | 96 |
| Example 10 | 10.95 | 184 | 85 | 107 |
| Example 11 | 10.97 | 186 | 83 | 112 |
| Example 12 | 8.94 | 150 | 85 | 114 |
| Comparative Example 1 | 13.4 | 216 | 85 | 119 |
| Comparative Example 2 | 11.09 | 179 | 82 | 124 |
| Comparative Example 3 | 12.55 | 209 | 83 | 116 |
| Comparative Example 4 | 10.49 | 176 | 80 | 117 |
| Comparative Example 5 | 11.86 | 197 | 85 | 116 |
| Comparative Example 6 | 14.60 | 238 | 85 | 116 |

Referring to Table 2, in the secondary batteries of Examples where the electrolyte solutions including the phosphate-based additive and the radical scavenger were used, an amount of inner gas generation was reduced even after the high-temperature storage, thereby reducing the thickness increase ratio of the battery. Further, even when stored at the high temperature, a low resistance increase ratio and a high-capacity retention were provided, and initial properties of the battery were maintained.

In the secondary batteries of Comparative Examples 1 and 2 that did not include the radical scavenger, side reactions in the electrolyte solution were not sufficiently suppressed at the high temperatures, and the battery expanded due to gas generation, thereby increasing the battery thickness. Further, the resistance increase ratio was increased during the high-temperature storage, resulting in deterioration of a battery performance.

In the batteries of Comparative Example 3 which included the electrolyte solution containing the phosphate-based additive in an amount of less than 1 wt % and Comparative Example 4 which included the electrolyte solution containing the phosphate-based additive in an amount greater than 10 wt %, the side reactions in the electrolyte solution were not effectively suppressed.

In the secondary battery of Comparative Example 6 that did not include both the phosphate-based additive and the radical scavenger, the thickness increase ratio of the battery was the highest during the high temperature storage.

What is claimed is:

1. An electrolyte solution for a lithium secondary battery, comprising:
a lithium salt;
an organic solvent;
a phosphate-based additive including a compound represented by Chemical Formula 1; and
a radical scavenger including a compound represented by Chemical Formula 2,
wherein a content of the phosphate-based additive is in a range from 1 wt % to 10 wt % based on a total weight of the electrolyte solution: 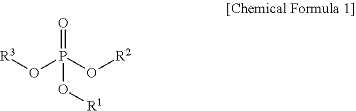
wherein, in Chemical Formula 1, R¹ to R³ are each independently a C6 to C18 aryl group, a C6 to C18 halogenated aryl group, a C1 to C10 alkyl group, a C1 to C10 halogenated alkyl group, or a C2 to C10 alkenyl group, 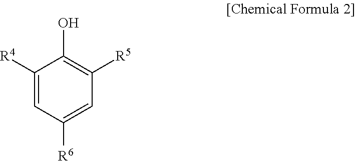
wherein, in Chemical Formula 2, R⁴ to R⁶ are each independently a C1 to C10 alkyl group, a C3 to C12 cycloalkyl group, a C2 to C10 alkenyl group, or a C6 to C18 aryl group.

2. The electrolyte solution for a lithium secondary battery of claim 1, wherein, in Chemical Formula 1, R¹ and R² are the same, and each of R¹ and R² is not the same as R³,
R¹ and R³ are the same and each of R¹ and R³ is not the same to R², or
R¹, R² and R³ are not the same as each other.

3. The electrolyte solution for a lithium secondary battery of claim 1, wherein, in Chemical Formula 1, R¹ and R² are each independently a C6 to C18 aryl group, a C6 to C18 halogenated aryl group, a C1 to C10 alkyl group, a C1 to C10 halogenated alkyl group, or a C2 to C10 alkyl group,
R³ is a C6 to C18 aryl group, a C6 to C18 halogenated aryl group, or a C1 to C10 halogenated alkyl group, and at least one of R¹ and R² is not the same as R³.

4. The electrolyte solution for a lithium secondary battery of claim 1, wherein, in Chemical Formula 1, R¹ is a C6 to C18 aryl group or a C6 to C18 halogenated aryl group, and R² is a C1 to C5 halogenated alkyl group.

5. The electrolyte solution for a lithium secondary battery of claim 1, wherein, in Chemical Formula 1, R¹ is a phenyl group or a fluorophenyl group,
R² is a trifluoromethyl group, a 2,2,2-trifluoroethyl group, a 3,3,3-trifluoropropyl group, a 2,2,3,3,3-pentafluoropropyl group or a 2,2,3,3,4,4,4-heptafluorobutyl group, and
R³ is phenyl group, a fluorophenyl group, a trifluoromethyl group, a 2,2,2-trifluoroethyl group, a 3,3,3-trifluoropropyl group, a 2,2,3,3,3-pentafluoropropyl group or a 2,2,3,3,4,4,4-heptafluorobutyl group.

6. The electrolyte solution for a lithium secondary battery of claim 1, wherein a content of the phosphate-based additive is in a range from 5 wt % to 10 wt % based on the total weight of the electrolyte solution.

7. The electrolyte solution for a lithium secondary battery of claim 1, wherein, in Chemical Formula 2, R⁴ and R⁵ are each independently a C3 to C10 branched alkyl group.

8. The electrolyte solution for a lithium secondary battery of claim 1, wherein, in Chemical Formula 2, R⁶ is a C1 to C10 linear alkyl group.

9. The electrolyte solution for a lithium secondary battery of claim 1, wherein the radical scavenger includes 2,6-di-tert-butyl-p-cresol.

10. The electrolyte solution for a lithium secondary battery of claim 1, wherein a content of the radical scavenger is in a range from 0.1 wt % to 2 wt % based on the total weight of the electrolyte solution.

11. The electrolyte solution for a lithium secondary battery of claim 1, wherein a ratio of the content of the phosphate-based additive to a content of the radical scavenger based on the total weight of the electrolyte solution is greater than 1, and less than or equal to 50.

12. The electrolyte solution for a lithium secondary battery of claim 1, wherein a ratio of the content of the phosphate-based additive to a content of the radical scavenger based on the total weight of the electrolyte solution is in a range from 2 to 20.

13. The electrolyte solution for a lithium secondary battery of claim 1, further comprising at least one auxiliary additive selected from the group consisting of a cyclic unsaturated carbonate-based compound, a fluorine-substituted cyclic carbonate-based compound, a sultone-based compound, a cyclic sulfate-based compound, a fluorine-substituted phosphate-based compound and an oxalato-borate-based compound.

14. The electrolyte solution for a lithium secondary battery of claim 13, wherein the auxiliary additive is included in an amount from 0.01 wt % to 5 wt % based on the total weight of the electrolyte solution.

15. A lithium secondary battery, comprising:
a case;
an electrode assembly accommodated in the case, the electrode assembly comprising a cathode and an anode that faces the cathode; and
the electrolyte solution for a lithium secondary battery of claim 1 accommodated in the case together with the electrode assembly.
